(19) United States
(12) Patent Application Publication
(10) Pub. No.: US 2022/0382079 A1
(43) Pub. Date: Dec. 1, 2022

(54) STRUCTURE OF CLIP-ON GLASSES

(71) Applicant: Grand Maple Optical Limited, Kowloon (HK)

(72) Inventor: Pik Fung CHAN, Kowloon (HK)

(21) Appl. No.: 17/804,540

(22) Filed: May 27, 2022

(30) Foreign Application Priority Data
May 28, 2021 (HK) 32021031923.4

(51) Int. Cl. G02C 9/04; G02C 5/00

(52) U.S. Cl. CPC G02C 9/04; G02C 5/008

(57) ABSTRACT

A structure of clip-on glasses includes a spectacles frame for holding the glasses; the spectacles frame provides an installation part for fixing the glasses and buckle parts for clipping the spectacles frame to the eyeglasses; the buckle parts include elastic buckles which are set on the upper edge of the spectacles frame; elastic buckles are made of elastic material and their contact surface with the eyeglasses are rubber. Because of using elastic material of the elastic buckles, the glasses can adapt to all kinds of eyeglasses with different designs and well clip on. Due to the rubber surface of the elastic buckle, the eyeglasses can prevent from scratching by the elastic buckle.

### FIELD OF THE INVENTION

The invention involves a clip-on lens structure fixed on the glasses.

### BACKGROUND OF THE INVENTION

At outdoors, the sun is so intense to wear appropriate sunglasses to prevent direct sunlight from causing damage to the eyes. For those who need to wear glasses, photosensitive lenses can be chosen. When exposed to light or ultraviolet rays, the photosensitive lens can quickly darken, block strong light and absorb ultraviolet rays, and absorb visible light neutrally; when he returns to the dark place, it can quickly restore the colorless and transparent to ensure the transmittance of the lens. However, the price of photosensitive lenses is relatively high. Another more commonly solution is to clip a set of sunglass lenses on the outside of the original glasses to block sunlight. Since such clip-on sunglasses need to be fixed with the original glasses, brackets are usually used to clamp them on the lenses or frames of the glasses. The solution for clamping the frame may lead to incompatibility of the clamping structure due to different designs of the frame. But clamping the lens is easy to scratch the lens of the spectacles due to the rigidity of the bracket currently used.

### SUMMARY OF THE INVENTION

In view of the aforesaid drawbacks of the prior art, the present invention provides the structure of clip-on glasses, the sun lenses and the like are clipped on the lenses of the glasses to prevent from scratching the lenses of the glasses.

Structure of clip-on glasses, comprises a frame for holding lenses, the frame at least consists of a mounting part for holding the lenses and a buckle part for fixing the frame to the glasses, and the buckle part comprises an elastic buckle, the elastic buckle is arranged on the upper edge of the frame and made of elastic material as a whole, and at least the contact surface of the elastic buckle which is contact with the lens of the glasses is made of rubber.

Furthermore, the frame is composed of at least a left lens frame and a right lens frame, the left lens frame and the right lens frame are fixed by a connecting beam, and the connecting beam can be bent to adjust the angle of the left lens frame and the right lens.

Furthermore, two sides of the upper edge of the lens are respectively provided with mounting fins protruding outward; the left lens frame and the right lens frame are respectively buckled with the upper edge of the lens, which includes a groove body for embedding the upper edge of the lens, at the two ends of the groove body, buckle holes are provided for cooperating with the mounting fins, the mounting fins cooperate with the buckle holes to fix the lens in the frame of the left and right lens.

Furthermore, a convex part and a concave part is provided in the middle of the upper edge of the lens and the middle of the groove bodies of the left lens frame and the right lens frame.

Furthermore, the frame is made of elastic plastic injection molding as a whole, and a metal sheet for bending and adjusting the angle between the left lens frame and the right lens frame is embedded in the connecting beam, the metal sheet is provided with a plurality of through holes for fixing with elastic plastics.

Furthermore, the frame is provided with a folding part, the folding part includes a folding bracket, the folding bracket and the frame are pivotally connected by a rotating shaft, and the buckle part is arranged on the folding bracket.

The invention has the following advantages: the elastic buckle is generally made of elastic plastic, which can adapt to different types and designs of glasses to achieve clipping and fixing. In addition, the contact surface between the elastic buckle and the lens of the glasses is rubber, which can effectively prevent the elastic buckle from scratching the glasses during use. The lens has a simple structure and is very convenient to use.

### BRIEF DESCRIPTION OF THE DRAWINGS

Below are explanations of the invention combining with drawings.

FIG. 1 is the perspective view of the embodiment 1 of the present invention.

FIG. 2 is the explosive view of the FIG. 1.

FIG. 3 is the perspective view of the embodiment 2 of the present invention.

FIG. 4 is the front view of the lenses.

In the figures: 1. the lenses, 2. the frame, 3. the elastic buckle, 4 the connecting beam, 5. the mounting fins, 6. the buckle holes, 7. the convex part, 8. the metal sheet, 9. the through holes, 10. the folding bracket.

### DESCRIPTION OF THE EMBODIMENTS

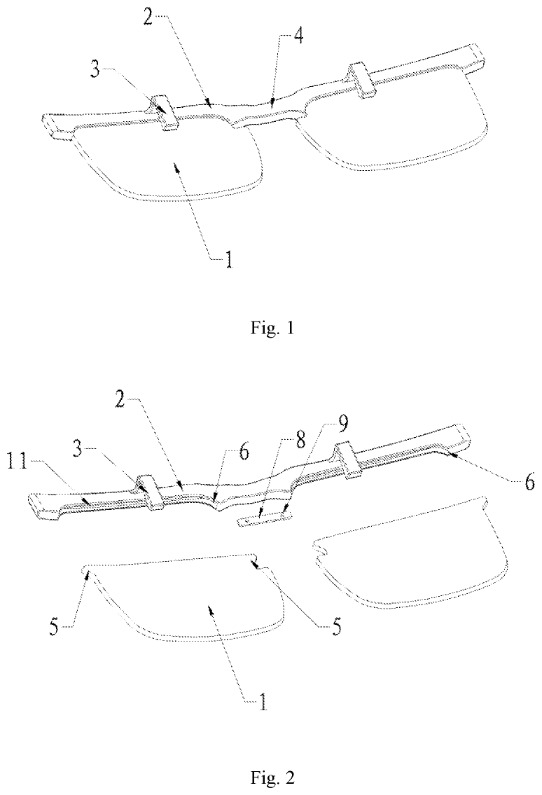

Referring to FIG. 1 and FIG. 2, the structure of clip-on glasses comprises a frame 2 for holding the lenses 1. The frame 2 at least consists of the mounting part for holding the lenses 1 and the buckle part for fixing the frame 2 to the glasses. And the buckle part comprises the elastic buckle 3. The elastic buckle 3 is arranged on the upper edge of the frame 2 and it is made of elastic material as a whole. At least the contact surface of the elastic buckle 3 which is contact with the lens of the glasses is made of plastic, which can adapt to different types and designs of glasses to achieve clipping and fixing. In addition, the contact surface between the elastic buckle 3 and the lens of the glasses is plastic, which can effectively prevent the elastic buckle from scratching the glasses during use. The lens has a simple structure and is very convenient to use.

Considering that glasses is quite different in structure, especially the lens angle of glasses and so on. In order to let the frame 2 adapt to the above different situations, the frame 2 is composed of at least a left lens frame and a right lens frame. The left lens frame and the right lens frame are fixed by a connecting beam which can be bent to adjust the angle of the left lens frame and the right lens. So that the user can conveniently adjust the left lens frame and the right lens frame by bending the connecting beam 4 according to the lens of the glasses, and the clip-on lens 1 can be adjusted appropriately for different glasses.

In generally, the existing clip-on lens 1 is usually completely fixed on the frame 2, and the user cannot replace it. And if different lenses 1 is required to meet the usage requirements of different environments, a whole new set of clip-on lenses 1 needs to be purchased separately. In order to solve the above problems, the present invention provides a clip-on structure for the replaceable lens 1, and the user can conveniently disassemble the lens 1 and install the required lens 1 according to the needs of use. More specifically, the entire frame 2 is strip-shaped and divided into a left lens frame and a right lens frame, and the left lens frame and the right lens frame are connected by a connecting beam 4. The bottom surfaces of the left lens frame and the right lens frame are provided with a groove body 11 for inserting the lens 1, and the upper edge of the lens 1 is inserted into the groove body 11 and fixed. Referring to FIG. 4, two sides of the upper edge of the lens 1 are respectively provided with mounting fins 5 protruding outward, and correspondingly, two ends of the groove body 11 are provided with buckle holes 6 for matching with the mounting fins 5. When replacing the clip-on lens 1, the frame 2 can be bent to increase the distance between the two snap holes 6, so that the mounting fins 5 can be disengaged from the buckle holes 6 and the lens 1 can be taken out, and then a new lens 1 can be inserted into the frame 2 After bending the frame 2, insert the mounting fins 5 of the new lens 1 into the buckle holes 6, and finally restore the frame 2 to complete the replacement of the new lens 1.

In order to further facilitate the positioning and installation of the lens 1 on the frame 2, the convex portion 7 is provided in the middle of the upper edge of the lens 1, and a concave portion is provided at the corresponding position of the groove body 11 of the left lens frame and the right lens frame. By the cooperation between the convex part 7 and the concave part, the lens 1 can be conveniently and accurately installed in the frame 2 and fixed.

As mentioned above, the frame 2 needs to be able to bend so that it can be adjusted to suit different glasses designs, and at the same time, it can also realize the replacement of different lenses 1. So, the frame 2 is made of elastic plastic injection molding as a whole, and the elastic metal sheet 8 is embedded in the connecting beam 4. When adjusting angle between the left lens frame and the right lens frame, the metal sheet in the connecting beam 4 can be bent and maintain the bending angle to prevent the connecting beam 4 from rebounding. In order to ensure that the metal sheet 8 can be well defined with the elastic plastic, the metal sheet 8 is provided with a plurality of through holes 9 for fixing with the elastic plastic. During injection molding, the elastic plastic will fill the through holes 9 for fixing.

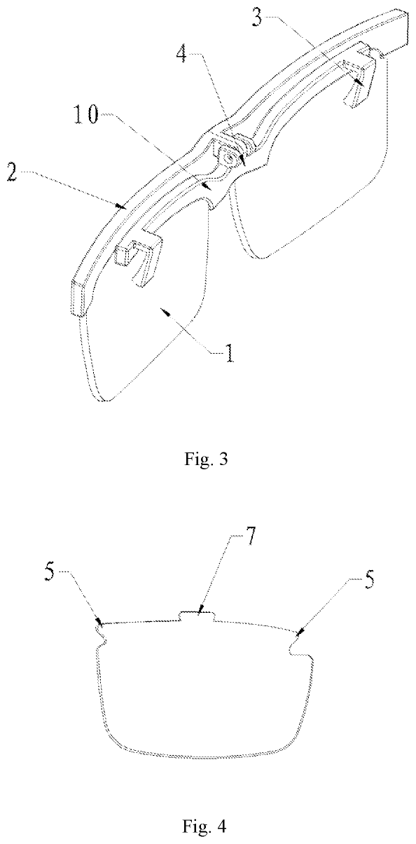

In addition, considering that the user may switch to different environments during use, and in order to facilitate the user to choose whether to use the clip-on lens 1 or not, a folding part is added to the frame 2 in present invention, and the folding part includes a folding bracket 10. The folding bracket 10 and the frame 2 are pivotally connected by a rotating shaft, refer to FIG. 3. The buckle part is provided with a folding bracket 10 to install the clip-on lens 1 on the glasses. If the clip-on lens 1 is necessary, the foldable bracket 10 can be rotated to turn the frame 2 to the glasses position. On the contrary, the frame will be turned up by the folding bracket 10, and return back to ordinary glasses.

1. A structure of clip-on glasses, comprises a frame for holding lenses, the frame at least consists of a mounting part for holding the lenses and a buckle part for fixing the frame to the glasses, and the buckle part comprises an elastic buckle, the elastic buckle is arranged on the upper edge of the frame and made of elastic material as a whole, and at least the contact surface of the elastic buckle which is contact with the lens of the glasses is made of rubber.

2. The structure of clip-on glasses of claim 1, wherein the frame is composed of at least a left lens frame and a right lens frame, the left lens frame and the right lens frame are fixed by a connecting beam, and the connecting beam can be bent to adjust the angle of the left lens frame and the right lens.

3. The structure of clip-on glasses of claim 2, wherein two sides of the upper edge of the lens are respectively provided with mounting fins protruding outward; the left lens frame and the right lens frame are respectively buckled with the upper edge of the lens, which includes a groove body for embedding the upper edge of the lens, at the two ends of the groove body, buckle holes are provided for cooperating with the mounting fins, the mounting fins cooperate with the buckle holes to fix the lens in the frame of the left and right lens.

4. The structure of clip-on glasses of claim 2, wherein a convex part and a concave part is provided in the middle of the upper edge of the lens and the middle of the groove bodies of the left lens frame and the right lens frame.

5. The structure of clip-on glasses of claim 1, wherein the frame is made of elastic plastic injection molding as a whole, and a metal sheet for bending and adjusting the angle between the left lens frame and the right lens frame is embedded in the connecting beam, the metal sheet is provided with a plurality of through holes for fixing with elastic plastics.

6. The structure of clip-on glasses of claim 1, wherein the frame is provided with a folding part, the folding part includes a folding bracket, the folding bracket and the frame are pivotally connected by a rotating shaft, and the buckle part is arranged on the folding bracket.

7. The structure of clip-on glasses of claim 3, wherein a convex part and a concave part is provided in the middle of the upper edge of the lens and the middle of the groove bodies of the left lens frame and the right lens frame.
